(19) United States
(12) Patent Application Publication
(10) Pub. No.: US 2011/0220624 A1
(43) Pub. Date: Sep. 15, 2011

(54) METHOD FOR USE OF A DEVICE FOR CUTTING THE PERIPHERAL ISOLATION LINES OF SOLAR PANELS

(75) Inventors: Miin-Tsair SU, Fengshan (TW); Sheng-Pin Wang, Kaohsiung City (TW); Jou-Chin Liao, Hsinchu City (TW); Sheng-Chao Li, Taichung City (TW); Chuan-Chang Lee, Yuanli Township (TW)

(73) Assignee: MARKETECH INTERNATIONAL CORP., Taipei (TW)

(21) Appl. No.: 12/721,115

(22) Filed: Mar. 10, 2010

(51) Int. Cl. B23K 26/00; B23K 26/02

(52) U.S. Cl. 219/121.72; 219/121.79

(57) ABSTRACT

The present invention provides a cutting method for a cutting device to cut the peripheral isolation lines of solar panels, having the following steps: preparing a solar panel and installing an image acquisition device at the corresponding position on the solar panel; setting the image acquisition device to move along the solar panel edge and acquire the image of the solar panel edge by means of located whole acquisition or line scan, and using an image processing device to calculate the location data of the edges of the solar panel; and setting a cutting device to cut the isolation line of the solar panel according to the edge location data. The present method can accurately judge the locations of the solar panel edges through image processing algorithm to find the parts near the margins and avoid defects, so that the solar panel can have maximum efficacy and utility.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a cutting method of the cutting device to cut the peripheral isolation lines of solar panels, and more particularly to an innovative method to accurately judge the solar panel edge positions through image acquisition and processing means.

2. Description of Related Art Including Information Disclosed Under 37 CFR 1.97 and 37 CFR 1.98

During production of solar panels, the panel peripheral indent spaces must go through a cutting procedure so that its conductive circuit layer can have preset rectangular isolation parts (called isolation lines in the present invention), and the electric conductive function can work according to preset path and range.

To maximize the utility of monolithic solar panels, the usable area shall be as broad as possible. At present there are several ways to realize this. A simple and practical way is to minimize the cut edges through an Edge Isolation Machine.

As shown in FIG. 1, the prior-art cutting method is to cut the solar panel 10 peripheral isolation line 11 in a rectangular shape, or in a preset cutting pattern. However, this method cannot determine the situation of damage of the solar panel edge. As a result, the isolation line may be too far from the solar panel edge. In this way, the usable area and utility of the solar panel cannot be maximized. Therefore, a breakthrough and improvement is necessary. Another problem of the above-disclosed method is that the cutting line cannot avoid possible defects due to the disability to determine the damage situation of the solar panel edge, resulting in an increased defect rate of finished products.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The “cutting method of the cutting device to cut the peripheral isolation lines of solar panels” disclosed in the present invention uses an image acquisition device to locate the solar panel edges, and uses an image processing device to calculate the technical characteristics of the acquired edge location data, so as to provide the cutting device accurate edge information, and to execute the cutting procedure according to the actual shapes of the solar panel edges. With this method, the solar panel edge locations can be accurately judged through image processing algorithm, so that the parts near the margins can be found and the defects can be avoided, maximizing the width of the range of the isolation line after cutting the solar panel, and as a result, maximizing the efficacy and utility of the solar panel, and greatly increasing the yield and quality of finished products. Hence, this method has a value for better industrial practice.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a schematic view depicting the conventional cutting method of solar panel peripheral isolation lines.

FIG. 2 is a schematic view of the cutting process of solar panel peripheral isolation lines of the present invention.

FIG. 3 is a schematic view depicting the steps of cutting the solar panel peripheral isolation lines of the present invention.

FIG. 4 is a schematic view depicting the structural section of the solar panel of the present invention after completing cutting of the isolation lines.

FIG. 5 is a schematic view depicting an embodiment of the cutting shape of the isolation line of the present invention.

FIG. 6 is a schematic view depicting another embodiment of cutting shape of the isolation line of the present invention.

FIG. 7 is a schematic view depicting another embodiment of the image acquisition device of the present invention.

FIG. 8 is a schematic view depicting a further embodiment of the image acquisition device of the present invention.

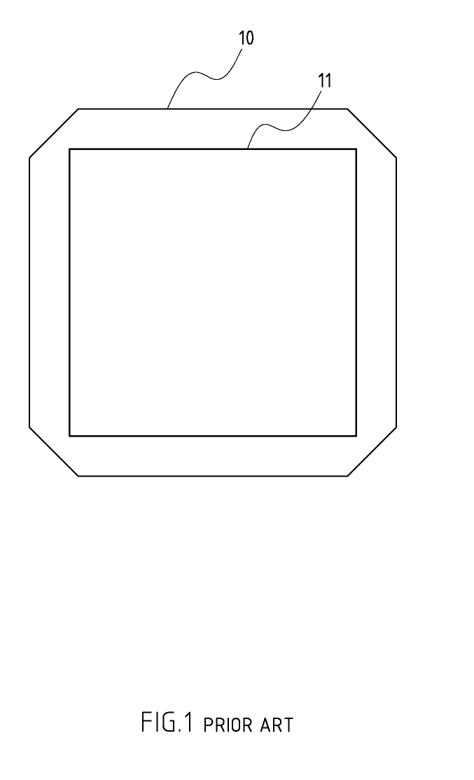

### DETAILED DESCRIPTION OF THE INVENTION

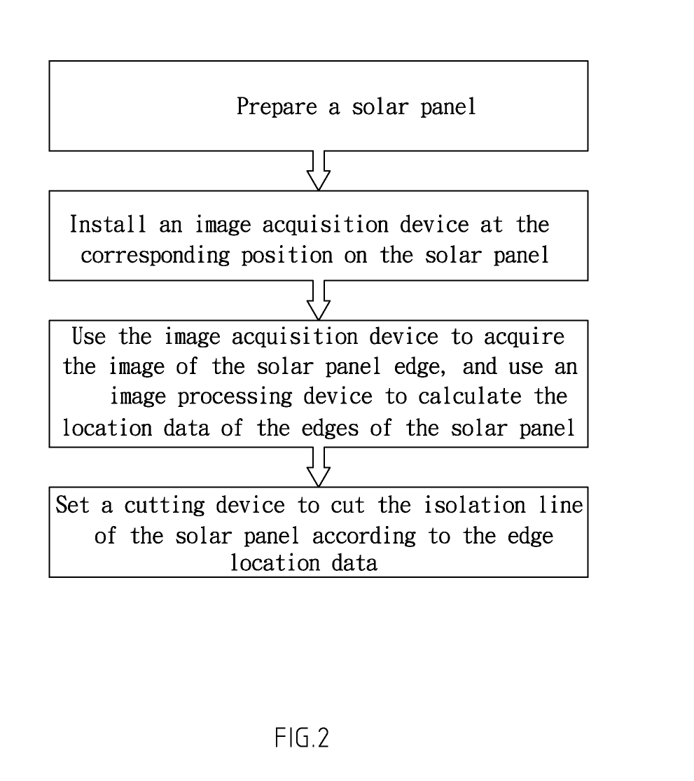

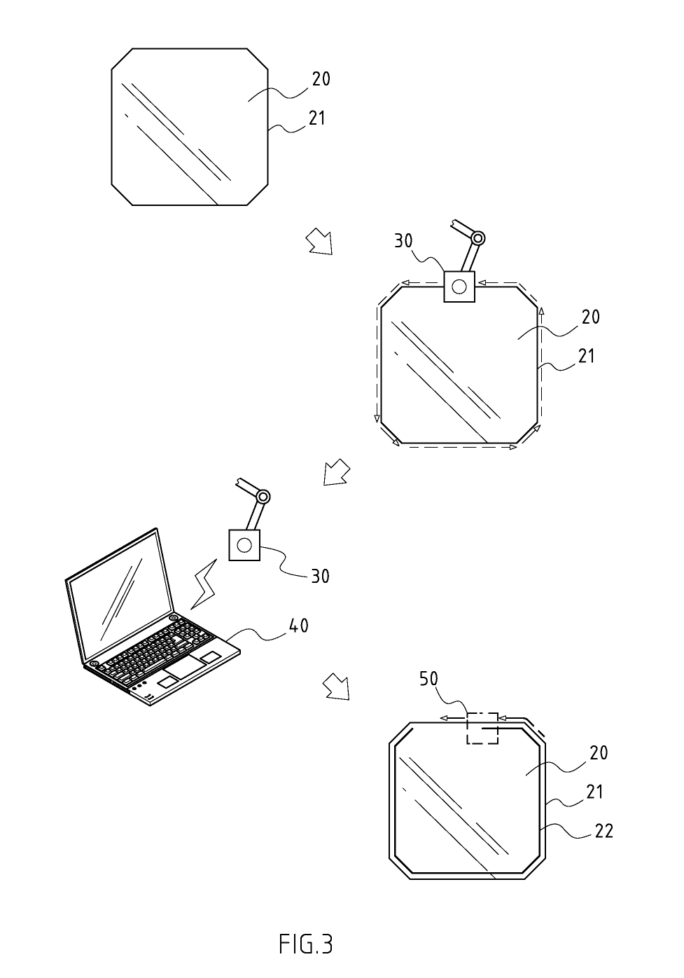

FIGS. 2 and 3 depict a preferred embodiment of the cutting method of the cutting device to cut the peripheral isolation lines of solar panels disclosed in the present invention, but such an embodiment is for description purpose only and shall not restrict the claims in patent application. Said cutting method of the cutting device to cut the peripheral isolation lines of solar panels comprises the following steps: prepare a solar panel 20; install an image acquisition device 30 at the correspondent position on the solar panel 20 (e.g. edge 21); set the image acquisition device 30 to acquire the image of the solar panel edge by means of line scan, or by means of located whole acquisition (means acquiring the whole solar panel range) along the edge 21 of the solar panel 20, and use an image processing device 40 to calculate the location data of the edges of the solar panel 20; and set a cutting device 50 to cut the isolation line 22 of the solar panel 20 according to the edge location data.

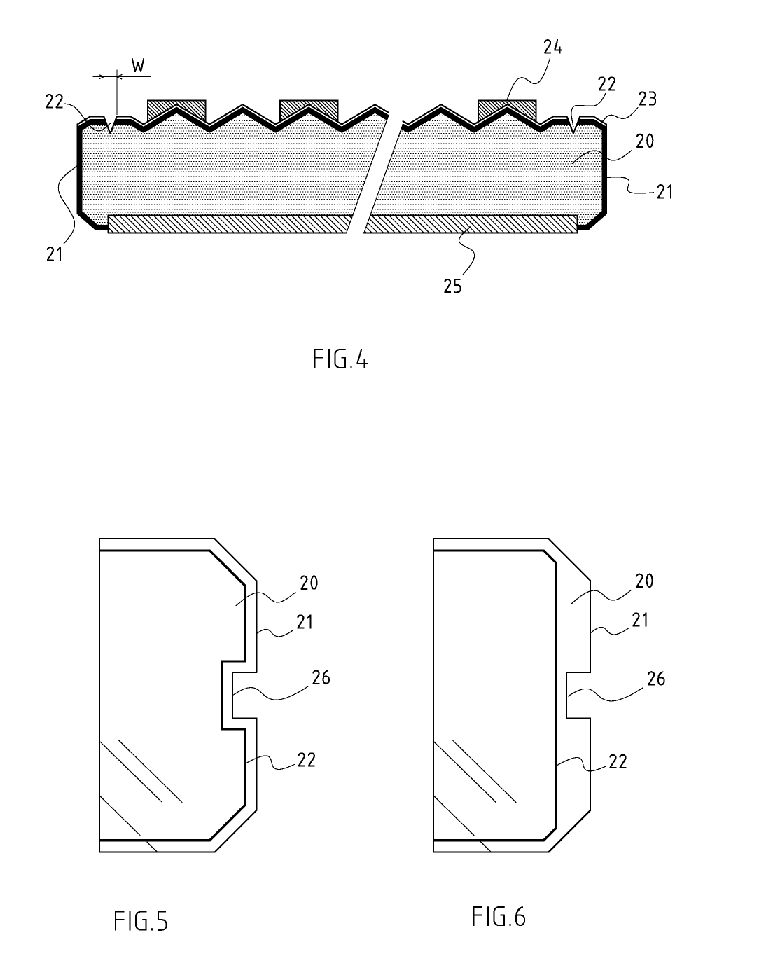

As a result of the cutting procedure, the structural section of the solar panel 20 is as shown in FIG. 4. Through the isolation line 22, the circuit layers 23 originally covering and formed on the front and back sides of the solar panel 20 can have an isolated and separated part, so that the Ag contact 24 configured on the front side of the solar panel 20 and the Al contact 25 configured on the back side can be separated.

Wherein, said cutting device 50 can be a laser cutting device. The thickness (marked by “W” in FIG. 4) of the isolation line 22 can be increased or reduced by adjusting the laser parameters. When the thickness of the isolation line 22 is reduced, the effective power generating area is relatively increased.

Wherein, the cutting path of the cutting device in cutting the isolation line 22 can be as shown in FIG. 5, which changes according to the variation of the locations of the edges 21 on different parts of the solar panel 10. For example, in FIG. 5, as a concave part 26 (can represent a defect or a specially planned shape) is formed on one place of the edge 21 of the solar panel 10, the isolation line 22 also curves and varies according to the shape of the concave part 26.

Referring to FIG. 6, the cutting path of the cutting device in cutting the isolation line 22 can also move according to the maximum path range obtained through calculation of the edge location data gathered after the image acquisition device moves a round; For example, as shown in FIG. 6, a concave part 26 is formed on one place of the solar panel 10 edge 21, the isolation line 22 does not curve and vary according to the shape of the concave part 26, but acquires the innermost concave location of the concave part 26, and executes a linear cutting by using the data of the innermost concave location as the reference value.

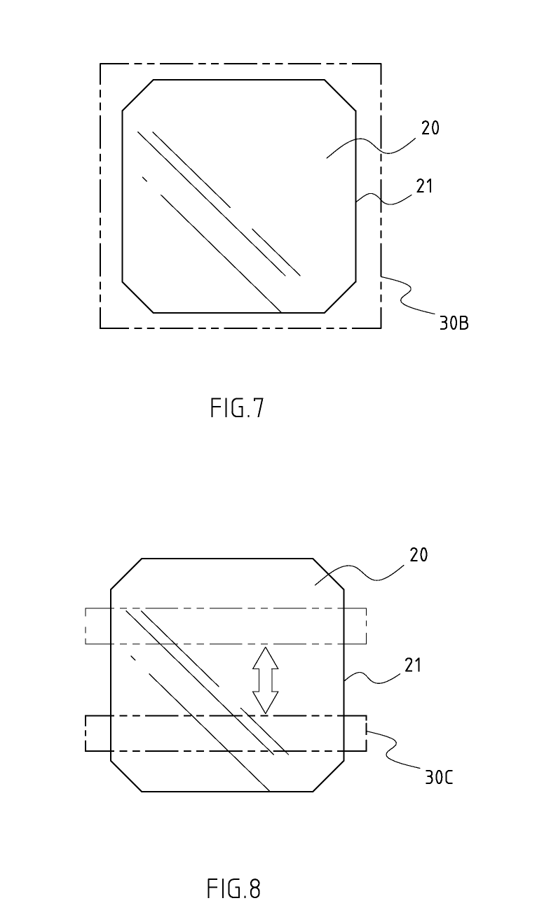

FIG. 7 depicts an embodiment of the image acquisition device 30B, which acquires the image of the solar panel 20 edges 21 by means of located whole acquisition (means acquiring the whole solar panel range).

FIG. 8 depicts an embodiment of the image acquisition device 30C, which acquires the image of the solar panel 20 edges 21 by means of Line Scan.

1. A cutting method of the cutting device to cut the peripheral isolation lines of solar panels, comprising the following steps:
preparing a solar panel;
installing an image acquisition device at a corresponding position on the solar panel;
setting the image acquisition device to acquire an image of the solar panel edge by means of located whole acquisition or line scan along the edge of the solar panel, and using an image processing device to calculate the edge location data of the solar panel; and
setting a cutting device to cut the isolation line of the solar panel according to the edge location data.

2. The method defined in claim 1, wherein said cutting device is a laser cutting device; the thickness of the isolation line can be increased or reduced by adjusting the laser parameters.

3. The method defined in claim 1, wherein the cutting path of said cutting device can change according to the variation of the locations of the edges on different parts of the solar panel.

4. The method defined in claim 1, wherein the cutting path of the cutting device can also move according to a maximum path range obtained through calculation of the edge location data gathered after the image acquisition device moves around.
